(19) United States
(12) Patent Application Publication
(10) Pub. No.: US 2026/0302575 A1
(43) Pub. Date: Oct. 1, 2026

(54) SECONDARY BATTERY AND METHOD FOR MANUFACTURING SECONDARY BATTERY

(71) Applicant: SAMSUNG SDI CO., LTD., Yongin-si (KR)

(72) Inventor: Heejung KO, Yongin-si (KR)

(21) Appl. No.: 19/563,526

(22) Filed: Mar. 11, 2026

(30) Foreign Application Priority Data
Mar. 25, 2025 (KR) 10-2025-0037952

(51) Int. Cl. H01M 50/655; H01M 50/325

(52) U.S. Cl. CPC H01M 50/655; H01M 50/325

(57) ABSTRACT

A secondary battery according to some embodiments of the present disclosure may include an electrode assembly, a can accommodating the electrode assembly through an opening formed on a side of the can, a cover that seals the opening of the can, and a sealer for sealing the through-hole of the can. The can may include a through-hole on another side of the can for injecting an electrolyte. The sealer may include a flat portion disposed on an outer side of the can to seal the through-hole of the can and a periphery of the through-hole of the can, a post portion connected to the flat portion and inserted into the through-hole of the can, and a plate portion connected to the post portion and disposed on an inner side of the can to seal the through-hole of the can and the periphery of the through-hole of the can.

### CROSS-REFERENCE TO RELATED APPLICATION

This application claims priority under 35 U.S.C. § 119 to Korean Patent Application No. 10-2025-0037952, filed in the Korean Intellectual Property Office on Mar. 25, 2025, the entire contents of which are hereby incorporated by reference.

### BACKGROUND

### Field

The present disclosure relates to a secondary battery and a method for manufacturing the secondary battery.

### Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

As one type of secondary battery, lithium-ion secondary batteries are widely used. When a lithium-ion secondary battery is continuously left at, or used at, a high temperature or is charged or discharged with a high current, internal gas may be generated due to deterioration of the cell. As internal pressure of a can increases due to the internal gas generated in the lithium-ion secondary battery, there is a risk that an internal electrode assembly may be damaged, thereby causing ignition. There have been various efforts to suppress the melting of internal components in a secondary battery or to prevent ignition caused by damage to the internal components.

The above information disclosed in this Background section is for enhancement of understanding of the background of the present disclosure, and therefore, it may contain information that does not constitute related (or prior) art.

### SUMMARY

An object of the present disclosure is to provide a secondary battery and a method for manufacturing the secondary battery for solving the above-mentioned problems.

These and other aspects and features of the present disclosure will be described in or will be apparent from the following description of embodiments of the present disclosure.

A secondary battery according to some embodiments of the present disclosure may include an electrode assembly, a can accommodating the electrode assembly through an opening formed on a side of the can, a cover that seals the opening of the can, and a sealer for sealing the through-hole of the can. The can may include a through-hole on another side of the can for injecting an electrolyte. The sealer may include a flat portion disposed on an outer side of the can to seal the through-hole of the can and a periphery of the through-hole of the can, a post portion connected to the flat portion and inserted into the through-hole of the can, and a plate portion connected to the post portion and disposed on an inner side of the can to seal the through-hole of the can and the periphery of the through-hole of the can.

In some embodiments, a material of the can may include stainless steel. A material of the cover may include stainless steel.

In some embodiments, the sealer may include an elastic material. The post portion stretches in a direction of a central axis of the through-hole of the can when inserted into the through-hole of the can. The flat portion presses against an outer surface of the can surrounding the through-hole of the can. The plate portion presses against an inner surface of the can surrounding the through-hole of the can.

In some embodiments, the sealer may include an elastic polymer material.

In some embodiments, a melting point of the sealer may be greater than or equal to 130° C.

In some embodiments, the sealer detaches from the through-hole of the can when a pressure greater than or equal to a threshold value forms inside the secondary battery.

In some embodiments, a geometry of the through-hole of the can may be a cylinder geometry or a polygonal tube geometry. A geometry of the post portion may be a circular cylinder geometry or a polygonal prism geometry.

In some embodiments, a geometry of the sealer, when inserted into the through-hole of the can, may be symmetrical with respect to a central axis of the through-hole of the can.

In some embodiments, a geometry of the flat portion may be a circular plate geometry, an elliptical plate geometry, or a polygonal plate geometry.

In some embodiments, a thickness of the flat portion may be greater than or equal to a thickness of the plate portion.

In some embodiments, a geometry of the plate portion may be a circular plate geometry, an elliptical plate geometry, or a polygonal plate geometry.

In some embodiments, an outer peripheral surface of the plate portion may have a chamfered geometry.

In some embodiments, a geometry of the plate portion may include a convex curved surface facing a direction opposite to a direction in which the post portion may be located.

In some embodiments, a thickness of the plate portion gradually decreases outward in a radial direction of the post portion.

In some embodiments, a geometry of the plate portion may include a concave curved surface facing a direction opposite to a direction in which the post portion may be located.

In some embodiments, a thickness of the plate portion may be less than or equal to a radius of the through-hole of the can.

In some embodiments, a diameter of the post portion, before being the sealer may be inserted into the through-hole of the can, may be less than or equal to a diameter of the through-hole of the can.

In some embodiments, the sealer may include an elastic material. A height of the post portion of the sealer, before the sealer may be inserted into the through-hole of the can, may be less than a height of the through-hole of the can.

A method for manufacturing a secondary battery according to some embodiments of the present disclosure may include preparing an electrode assembly, preparing a can including an opening formed on a side of the can and a through-hole formed on another side of the can, inserting the electrode assembly through the opening of the can, coupling a cover to the opening of the can, injecting an electrolyte into the can through the through-hole of the can, and inserting a sealer into the through-hole of the can to seal the through-hole of the can. The sealer may include a flat portion disposed on an outer side of the can to seal a periphery of the through-hole of the can, a post portion connected to the flat portion and inserted into the through-hole of the can, and a plate portion connected to the post portion, the plate portion being disposed on an inner side of the can and sealing the periphery of the through-hole of the can.

In some embodiments, inserting the sealer into the through-hole of the can to seal the through-hole of the can may include pressing the flat portion using a presser so that the plate portion passes through the through-hole of the can while in a folded state.

According to some embodiments of the present disclosure, a secondary battery with improved safety and a method for manufacturing the secondary battery may be provided.

According to some embodiments of the present disclosure, a sealer may be detached from a through-hole when a pressure greater than or equal to a threshold value is generated inside the secondary battery.

According to some embodiments of the present disclosure, when a pressure greater than or equal to a threshold value is generated inside the secondary battery, the sealer detaches from the through-hole due to the internal pressure of the secondary battery, and internal gas of the secondary battery discharges to the outside. Accordingly, thus, safety of the secondary battery may be improved.

According to some embodiments of the present disclosure, by arranging a sealer that prevents electrolyte leakage and may detach from a through-hole when a pressure greater than or equal to a threshold value is generated inside the secondary battery, a manufacturing process of the secondary battery may be simplified, and, thus, manufacturing time and manufacturing costs of the secondary battery may be reduced.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view illustrating a secondary battery according to some embodiments of the present disclosure.

FIG. 2 is an exploded perspective view illustrating a secondary battery according to some embodiments of the present disclosure.

FIG. 3 is a perspective view illustrating a sealer for a can according to some embodiments of the present disclosure.

FIG. 4 is a cross-sectional view illustrating a diameter of a through-hole and a sealer for a can according to some embodiments of the present disclosure.

FIG. 5 is a cross-sectional view illustrating a height of a through-hole and a sealer for a can according to some embodiments of the present disclosure.

FIG. 6 is a cross-sectional view illustrating a sealer for a can including a chamfered geometry according to some embodiments of the present disclosure.

FIG. 7 is a cross-sectional view illustrating a sealer for a can including a convex curved surface according to some embodiments of the present disclosure.

FIG. 8 is a cross-sectional view illustrating a sealer for a can including a concave curved surface according to some embodiments of the present disclosure.

FIG. 9 is a diagram illustrating a process of inserting a sealer into a through-hole of a can using a presser according to some embodiments of the present disclosure.

FIG. 10 is a diagram illustrating a sealer being detached from a through-hole of a can when an internal pressure of a secondary battery is greater than or equal to a threshold value according to some embodiments of the present disclosure.

FIG. 11 is a flowchart illustrating a method for manufacturing a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements and/or layers may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lesser numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements and/or features as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, sizes and relative sizes of layers and regions shown in the drawings may be exaggerated for clarity of description. The sizes shown in the drawings are for convenience of understanding and are not limited to what is shown in the drawings. In addition, the same reference numerals refer to the same constituent elements throughout the specification.

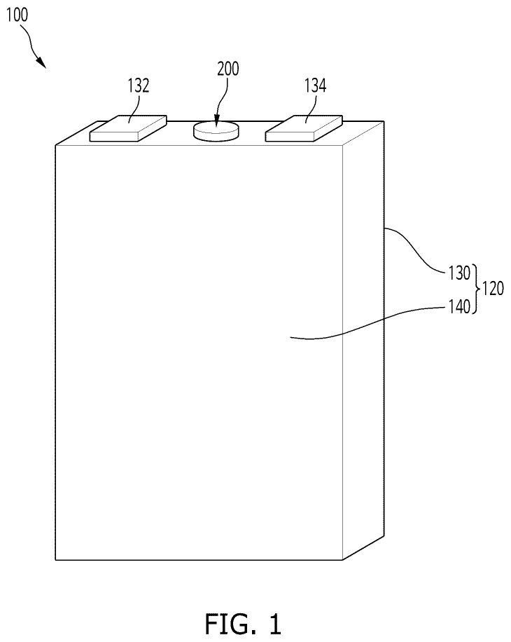

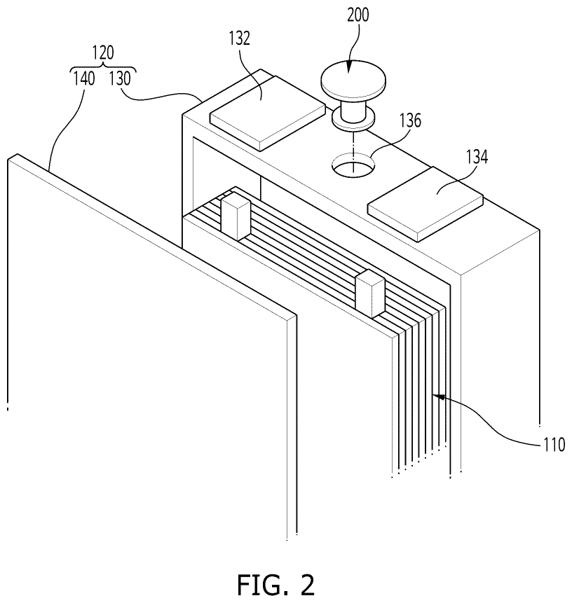

FIG. 1 is a perspective view illustrating a secondary battery according to some embodiments of the present disclosure. FIG. 2 is an exploded perspective view illustrating the secondary battery according to some embodiments of the present disclosure.

Referring to FIG. 1 and FIG. 2, a secondary battery 100 may include an electrode assembly 110 including a positive electrode, a separator, and a negative electrode, and a case 120 accommodating the electrode assembly 110. The case 120 may include a can 130 that accommodates the electrode assembly 110 through an opening formed on a side of the case, and a cover 140 that seals the opening of the can 130. The case 120 shown in FIG. 1 may include stainless use steel (SUS), so that the secondary battery 100 may be an SUS can type secondary battery. However, the case 120 is not limited thereto. The can 130 and the cover 140 may be formed of a conductive metal such as stainless steel (SUS), aluminum, an aluminum alloy, or nickel-plated steel to form the overall appearance of the secondary battery 100.

Each of the positive electrode and the negative electrode of the electrode assembly 110 may include a current collector made of a thin metal foil having a coated portion on which an active material is coated and an uncoated portion on which an active material is not coated. The positive electrode and the negative electrode are wound after interposing the separator, which is an insulator, therebetween. However, the present disclosure is not limited thereto, and the electrode assembly may have a structure in which a positive electrode and a negative electrode, each made of a plurality of sheets, are alternately stacked with a separator interposed therebetween.

The secondary battery 100 shown in FIG. 1 and FIG. 2 may be a lithium secondary battery.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

Al may be used as the current collector, but the current collector is not limited thereto.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≥0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{b}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

In the electrode assembly 110, a positive electrode tab may be connected to a side of the positive electrode, and a negative electrode tab may be connected to a side of the negative electrode. The positive electrode tab and the negative electrode tab may be connected by welding a tab to an uncoated portion of the positive electrode and the negative electrode and may be formed by stamping the uncoated portion of the positive electrode and the negative electrode. In a stacked state, the positive electrode tab and the negative electrode tab may be arranged in parallel with a certain interval. In some embodiments, in a wound state, the positive electrode tab and the negative electrode tab may be arranged in parallel with a certain interval. However, in some embodiments, the positive electrode tab and the negative electrode tab may be disposed on different side surfaces of the electrode assembly 110. Further, in some embodiments, the electrode assembly 110 may have any structure including an electrode tab.

The can 130 may include a receiving portion and a flange (not shown). Specifically, a receiving portion in which the electrode assembly 110 is received may be formed in a substantially central region of the can 130 by press processing. In addition, a flange extending outward from an upper end of the receiving portion may be formed. A flange may be formed in four directions at an upper edge of the receiving portion.

The can 130 may include a positive electrode terminal 132 and a negative electrode terminal 134. The positive electrode terminal 132 may be electrically connected to a positive electrode tab of the electrode assembly 110, and the negative electrode terminal 134 may be electrically connected to a negative electrode tab of the electrode assembly 110. In addition, the positive electrode terminal 132 and the negative electrode terminal 134 may be formed on a surface of the can 130. However, the positions of the positive electrode terminal 132 and the negative electrode terminal 134 according to the present disclosure are not limited to the positions shown in FIG. 1, and the positive electrode terminal 132 and the negative electrode terminal 134 may have other positions.

In some embodiments, the can 130 may include a through-hole 136 for injecting an electrolyte. The through-hole 136 may be a through-hole formed on a surface of the can 130 and may be formed for injecting an electrolyte into the case 120 of the secondary battery 100 after the can 130 and the cover 140 are joined and sealed. After the electrolyte is injected, a sealer 200 may be coupled to seal the through-hole 136. Although the through-hole 136 according to the present disclosure is shown to be located between the positive electrode terminal 132 and the negative electrode terminal 134, the present disclosure is not limited thereto and may have various modifications.

In some embodiments, the sealer 200 may include a flat portion disposed on an outer side of the can 130 to seal the through-hole 136 and to seal a periphery of the through-hole 136. Also, the sealer 200 may include a post portion connected to the flat portion and inserted into the through-hole 136. Further, the sealer 200 may include a plate portion connected to the post portion and disposed on an inner side of the can 130 to seal the through-hole 136 and to seal the periphery of the through-hole 136. The sealer 200 may include an elastic material. Accordingly, when a pressure greater than or equal to a threshold value is generated inside the secondary battery 100, the sealer 200 may detach from the through-hole 136.

The can 130 and the cover 140 may be joined to form an appearance of the secondary battery 100. The can 130 and the cover 140 may be metal-joined (e.g., welded, brazed, and/or soldered). A flange of the can 130 and an edge of the cover 140 may be joined. In addition, after the can 130 and the cover 140 are joined, at least a part of the flange (not shown) may be cut using a laser to improve the energy density of the secondary battery 100.

The secondary battery 100 may be a lithium battery cell or a sodium battery cell. However, the present disclosure is not limited thereto, and the secondary battery 100 may include any battery that can repeatedly provide electricity by charging and discharging. In some embodiments, when the secondary battery 100 is a lithium battery cell, the secondary battery 100 may be used in an electric vehicle (EV) because the secondary battery 100 has excellent cycle life characteristics and excellent high-rate characteristics. The secondary battery 100 may be used in a hybrid vehicle such as a plug-in hybrid electric vehicle (PHEV). In addition, the lithium battery cell may be used in a field that requires storage of a large amount of electric power. For example, the lithium battery cell may be used in an electric bicycle or a power tool.

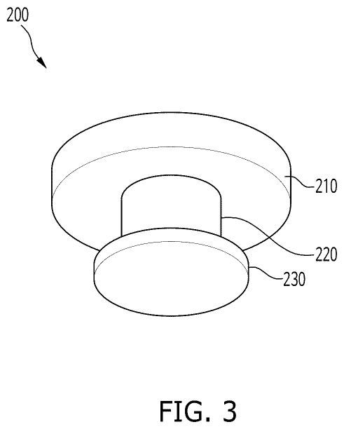

FIG. 3 is a perspective view illustrating a sealer for a can according to some embodiments of the present disclosure.

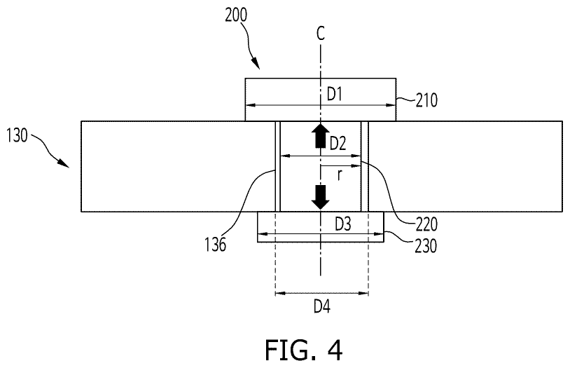

Referring to FIG. 3, a sealer 200 may include a flat portion 210 disposed on an outer side of a can 130 (see FIG. 4) to seal a through-hole 136 (see FIG. 4) formed on a surface of a case and to seal a periphery of the through-hole 136. Also, the sealer 200 may include a post portion 220 connected to the flat portion 210 and inserted into the through-hole 136. Further, the sealer 200 may include a plate portion 230 connected to the post portion 220 and disposed on an inner side of the can 130 to seal the through-hole 136 and to seal the periphery of the through-hole 136.

When an internal pressure of a secondary battery 100 (see FIG. 1) including a through-hole 136 (see FIG. 2) into which the sealer 200 is inserted increases, an internal temperature of the secondary battery 100 may rise to about 150° C. When the internal pressure of the secondary battery 100 is greater than or equal to a pressure at which the sealer 200 is detached, the sealer 200 may detach from the through-hole 136 of the can 130, and the internal pressure of the secondary battery 100 may be discharged. Therefore, a material or a physical property of the sealer 200 may be set so that the sealer 200 does not rupture before the internal pressure of the secondary battery 100 reaches the pressure at which the sealer 200 is detached.

In some embodiments, a melting point of the sealer 200 may be greater than or equal to 130° C. The sealer 200 may include a material having high heat resistance. The high heat resistance material is a material that can maintain physical and chemical properties at a high temperature and may have heat resistance that does not rupture even when an internal temperature of the secondary battery 100 reaches about 130° C. When the sealer 200 has the high heat resistance material having such characteristics, the sealer 200 may not be damaged even if an internal temperature of the secondary battery 100 rises to about 130° C. before the internal pressure of the secondary battery 100 reaches a pressure at which the sealer 200 is detached.

In some embodiments, the sealer 200 may include an elastic material. An elastic material may refer to a substance that has a characteristic of returning to its original geometry when a force is removed after the material has been deformed by an externally applied force. Due to the characteristics of this material, a height of the post portion 220 may be less than a height of the through-hole 136 in a state before being inserted into the through-hole 136. When inserted into the through-hole 136, the height of the post portion 220 may increase to correspond to the height of the through-hole 136. The meaning of “corresponds to” may be that the height of the post portion 220 is the same as the height of the through-hole 136 or is substantially the same within a predetermined error range.

In relation to the elasticity described above, the sealer 200 may include an elastic polymer material. The elastic polymer material may include at least one of rubber, silicone, thermoplastic polyurethane (TPU), and thermoplastic elastomer (TPE). As a result, the plate portion 230 of the sealer 200 may be unfolded after passing through the through-hole 136 in a folded state. Under a normal state in which the secondary battery operates normally, the plate portion 230 of the sealer 200 may be disposed on an inner side of the can 130 to seal the through-hole 136.

Meanwhile, under a specific state or under specific environmental conditions that are not a normal state, the secondary battery may operate abnormally, and an internal pressure of the secondary battery may be increased. At least a part of the plate portion 230 may be folded by the internal pressure of the secondary battery. Accordingly, when a pressure greater than or equal to a threshold value is generated inside the secondary battery, the sealer 200 may detach from the through-hole 136 by the internal pressure in the secondary battery. As a result, an internal gas of the secondary battery is discharged to outside the secondary battery, and, thus, the safety of the secondary battery may be improved.

Due to the structural features described above, by disposing the sealer 200 that prevents electrolyte leakage and may detach from the through-hole 136 when a pressure greater than or equal to a threshold value is generated inside the secondary battery, a manufacturing process of the secondary battery may be simplified, and, thus, a manufacturing time and a manufacturing cost may be reduced.

FIG. 4 is a cross-sectional view illustrating a diameter of a through-hole and a sealer for a can according to some embodiments of the present disclosure. Descriptions of the aspects shown in FIG. 4 that have been described for FIG. 3 are omitted.

In some embodiments, a geometry of the through-hole 136 is one of a cylinder and a polygonal tube, and a geometry of the post portion 220 may be one of a circular cylinder and a polygonal prism. The through-hole 136 may have a cylindrical geometry, and the post portion 220 of the sealer 200 may have a cylindrical geometry. A diameter D2 of the post portion 220 may be less than a diameter D4 of the through-hole 136 when the sealer is inserted into the through-hole 136. As a result, when a pressure greater than or equal to a threshold value is generated inside the secondary battery, the sealer 200 may detach from the through-hole 136.

In some embodiments, a geometry of the sealer 200 may be symmetrical with respect to a central axis C of the through-hole 136. A geometry of the flat portion 210 and a geometry of the plate portion 230 may be one of a circular plate, an elliptical plate, and a polygonal plate. As a result, an internal pressure of the secondary battery acts uniformly on the sealer 200, so that the sealer 200 may be properly detached from the through-hole 136.

In some embodiments, the flat portion 210 may have a geometry extending outward in a radial direction r of the post portion 220. Specifically, a diameter D1 of the flat portion 210 may be greater than a diameter D2 of the post portion 220 and a diameter D4 of the through-hole 136. As a result, the flat portion 210 may seal the through-hole 136 and a periphery of the through-hole 136. As a result, leakage of an electrolyte to an outside of the can 130 may be prevented.

In some embodiments, the plate portion 230 may have a geometry extending outward in a radial direction r of the post portion 220. Specifically, a diameter D3 of the plate portion 230 may be greater than a diameter D2 of the post portion 220 and a diameter D4 of the through-hole 136. As a result, the plate portion 230 may seal the through-hole 136 and a periphery of the through-hole 136. Thus, leakage of an electrolyte to an outside of the can 130 may be prevented.

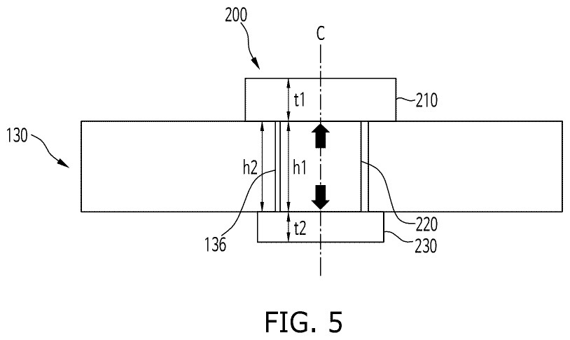

FIG. 5 is a cross-sectional view illustrating a height of a through-hole and a sealer for a can according to some embodiments of the present disclosure. Descriptions of the aspects shown in FIG. 5 that have been described for FIG. 3 and FIG. 4 are omitted.

In some embodiments, the can 130 may be composed of a stainless steel (SUS) material. Compared to a case where the can 130 is composed of a material such as aluminum or iron, rigidity of the can 130 may be increased. Accordingly, it is possible to manufacture the can 130 having a target strength while reducing the thickness of the can 130, so that the energy efficiency of the secondary battery may be increased. In addition, damage to the can 130 due to melting by high-temperature gas or by byproducts discharged through the through-hole 136 may be prevented.

A thickness of the can 130 may correspond to a height h2 of the through-hole 136. The meaning of “corresponds to” may mean that the thickness of the can 130 is the same as the height h2 of the through-hole 136 or is substantially the same within a predetermined error range.

In some embodiments, the sealer 200 may include an elastic material. The post portion 220 may be stretched in a direction of a central axis C of the through-hole 136 when the sealer 200 is inserted into the through-hole 136. A height h1 of the post portion 220 may correspond to a height h2 of the through-hole 136. As the post portion 220 is stretched, an elastic force may be applied to the flat portion 210 and the plate portion 230, respectively, in a direction toward the post portion 220. Accordingly, the flat portion 210 may be pressed against an outer surface of the can 130 surrounding the through-hole 136, and the plate portion 230 may be pressed against an inner surface of the can 130 surrounding the through-hole 136. As a result, the flat portion 210 and the plate portion 230 may seal the through-hole 136 and a periphery of the through-hole 136. As a result, leakage of an electrolyte to an outside of the can 130 may be prevented.

In some embodiments, a thickness t1 of the flat portion 210 may be greater than or equal to a maximum thickness t2 of the plate portion 230. Thus, when a pressure greater than or equal to a threshold value is generated inside the secondary battery, the plate portion 230 may be easily folded, so that the sealer 200 may properly detach from the through-hole 136.

In some embodiments, a maximum thickness t2 of the plate portion 230 may be set in consideration of an internal pressure corresponding to a threshold value of the secondary battery. The maximum thickness t2 of the plate portion 230 may be less than or equal to a radius of the through-hole 136. The radius of the through-hole 136 may be the same as half of a diameter D4 (see FIG. 4) of the through-hole 136. As a result, when a pressure greater than or equal to a threshold value is generated inside the secondary battery, the plate portion 230 may pass through the through-hole 136, so that the sealer 200 may detach from the through-hole 136.

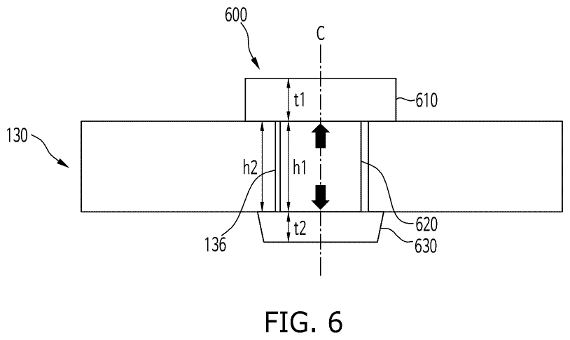

FIG. 6 is a cross-sectional view illustrating a sealer for a can including a chamfered geometry according to some embodiments of the present disclosure. Descriptions of the configurations shown in FIG. 6 that have been described for FIG. 3 to FIG. 5 are omitted.

In some embodiments, an outer peripheral surface of a plate portion 630 may have a chamfered geometry. The outer peripheral surface of the plate portion 630 may have a geometry inclined in an inner direction of the can 130 (a lower direction in FIG. 6). In some embodiments, the outer peripheral surface of the plate portion 630 may have a geometry inclined in an outer direction of the can 130 (an upper direction in FIG. 6). The outer peripheral surface of the plate portion 630 may have an inclination angle from about 0 degrees to about 90 degrees with respect to a central axis C of the through-hole 136.

In some embodiments, a maximum thickness t2 of the plate portion 630 may be less than or equal to a radius of the through-hole 136. The radius of the through-hole 136 may be the same as half of a diameter D4 (see FIG. 4) of the through-hole 136. Thus, when a pressure greater than or equal to a threshold value is generated inside the secondary battery, the plate portion 630 may pass through the through-hole 136, so that a sealer 600 may detach from the through-hole 136.

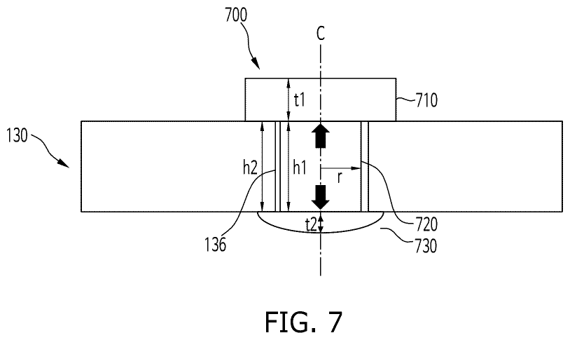

FIG. 7 is a cross-sectional view illustrating a sealer for a can including a convex curved surface according to some embodiments of the present disclosure. Descriptions of the configurations shown in FIG. 7 that have been described for FIG. 3 to FIG. 5 are omitted.

In some embodiments, a geometry of a plate portion 730 may include a convex curved surface facing a direction opposite to a direction in which a post portion 720 is located. An upper surface of the plate portion 730 may be a flat surface, and a lower surface of the plate portion 730 may include a convex curved surface facing the direction opposite to a direction in which the post portion 720 is located. In some embodiments, each of the upper surface of the plate portion 730 and the lower surface of the plate portion 730 may include a convex curved surface facing the direction opposite to the direction in which the post portion 720 is located.

In some embodiments, a thickness t2 of the plate portion 730 may gradually decrease outward in a radial direction r of the post portion 720. Thus, when a pressure greater than or equal to a threshold value is generated inside the secondary battery, the plate portion 730 is easily folded, so that the sealer 200 may be properly detached from the through-hole 136.

In some embodiments, a maximum thickness t2 of the plate portion 730 may be less than or equal to a radius of the through-hole 136. The radius of the through-hole 136 may be the same as half of a diameter D4 (see FIG. 4) of the through-hole 136. Thus, when a pressure greater than or equal to a threshold value is generated inside the secondary battery, the plate portion 730 may pass through the through-hole 136, so that a sealer 700 may detach from the through-hole 136.

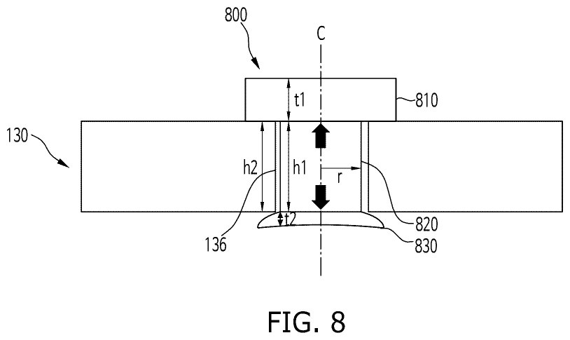

FIG. 8 is a cross-sectional view illustrating a sealer for a can including a concave curved surface according to some embodiments of the present disclosure. Descriptions of the configurations shown in FIG. 8 that have been described for FIG. 3 to FIG. 5 are omitted.

In some embodiments, a geometry of a plate portion 830 may include a concave curved surface facing a direction opposite to a direction in which a post portion 820 is located. A lower surface of the plate portion 830 may include a concave curved surface facing the direction opposite to the direction in which the post portion 820 is located.

In some embodiments, a maximum thickness t2 of the plate portion 830 may be less than or equal to a radius of the through-hole 136. The radius of the through-hole 136 may be the same as half of a diameter D4 (see FIG. 4) of the through-hole 136. As a result, when a pressure greater than or equal to a threshold value is generated inside the secondary battery, the plate portion 830 may pass through the through-hole 136, so that a sealer 800 may detach from the through-hole 136.

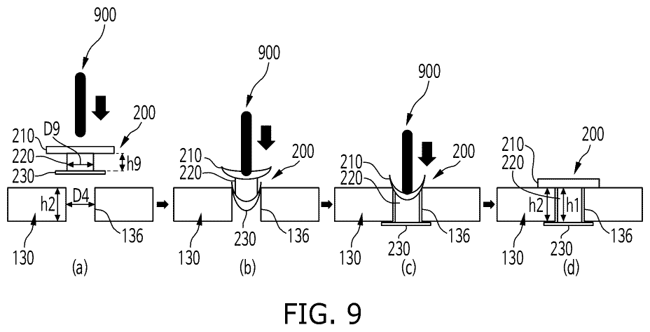

FIG. 9 is a diagram illustrating a process of inserting a sealer into a through-hole of a can using a presser according to some embodiments of the present disclosure.

As shown in FIG. 9(a), a sealer 200 may be located on an outer side of a can 130 surrounding a through-hole 136. A presser 900 may move toward a flat portion 210 of the sealer 200. In some embodiments, a diameter D9 of a post portion 220, before being inserted into the through-hole 136, may be less than or equal to a diameter D4 of the through-hole 136. As a result, the sealer 200 may be easily inserted into the through-hole 136. In some embodiments, the sealer 200 may include an elastic material. A height h9 of the post portion 220 of the sealer 200, before being inserted into the through-hole 136, may be less than a height h2 of the through-hole 136.

As shown in FIG. 9(b), the flat portion 210 of the sealer 200 may be pressed by the presser 900 in a direction toward the through-hole 136. In some embodiments, a plate portion 230 of the sealer 200 may be inserted into the through-hole 136 in a folded state.

As shown in FIG. 9(c), the plate portion 230 of the sealer 200 may be unfolded on an inner side of the can 130 after passing through the through-hole 136 in a folded state.

As shown in FIG. 9(d), the flat portion 210 of the sealer 200 may be unfolded on an outer side of the can 130. In some embodiments, the post portion 220 may be stretched in a direction of a central axis C (see FIG. 5) of the through-hole 136 when inserted into the through-hole 136. A height h1 of the post portion 220 may correspond to a height h2 of the through-hole 136. As the post portion 220 is stretched, an elastic force may be applied to the flat portion 210 and the plate portion 230, respectively, in a direction toward the post portion 220. The meaning of “corresponds to” may be that the height h1 of the post portion 220 is the same as the height h2 of the through-hole 136 or is substantially the same within a predetermined error range.

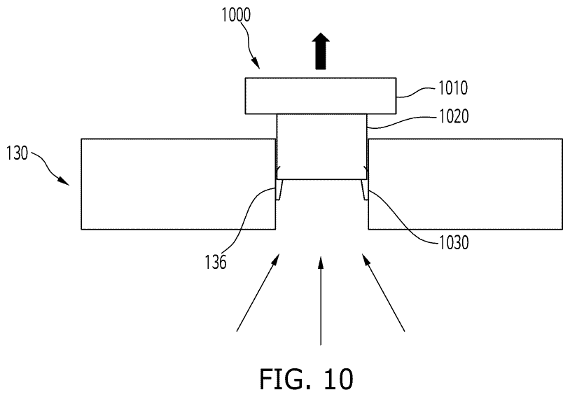

FIG. 10 is a diagram illustrating a sealer being detached from a through-hole of a can when an internal pressure of a secondary battery is greater than or equal to a threshold value according to some embodiments of the present disclosure.

Referring to FIG. 10, a sealer 1000 may detach from a through-hole 136 when a pressure greater than or equal to a threshold value is generated inside a secondary battery. An elastic material of the sealer 1000 may be set in consideration of a modulus of elasticity according to an internal pressure corresponding to the threshold value of the secondary battery. When a pressure greater than or equal to a threshold value is generated inside the secondary battery, a plate portion 1030 may be folded in a direction opposite to a direction in which a post portion 1020 is located. Accordingly, the plate portion 1030 may pass through the through-hole 136 to an outer side of the can 130 (an upper direction in FIG. 10) in a folded state. Thus, the sealer 1000 may detach from the through-hole 136, and an internal gas of the secondary battery is discharged to an outside of the secondary battery. Thus, the safety of the secondary battery may be improved.

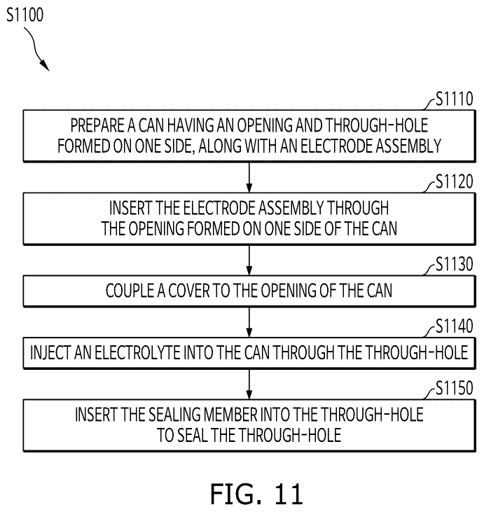

FIG. 11 is a flowchart illustrating a method for manufacturing a secondary battery according to some embodiments of the present disclosure.

A method for manufacturing a secondary battery S1100 may begin by preparing a can having an opening and through-hole formed on a side of the can, along with an electrode assembly S1110. In some embodiments, the can may include a receiving portion and a flange. Specifically, a receiving portion in which the electrode assembly is received may be formed in a substantially central region of the can by press processing. In addition, a flange extending outward from an upper end of the receiving portion may be formed. A flange may be formed in four directions at an upper edge of the receiving portion. In some embodiments, the can may include a positive electrode terminal and a negative electrode terminal. The positive electrode terminal may be electrically connected to a positive electrode tab of the electrode assembly, and the negative electrode terminal may be electrically connected to a negative electrode tab of the electrode assembly. In addition, the positive electrode terminal and the negative electrode terminal may be formed on another surface of the can. The positive electrode terminal and the negative electrode terminal may be formed at various positions. In some embodiments, the can may include a through-hole for injecting an electrolyte. The through-hole may be a through-hole formed on a surface of the can and may be formed to accept an electrolyte into a case of the secondary battery after the can and a cover are joined and sealed. After the electrolyte is injected, a sealer may seal the through-hole. The through-hole may be formed between the positive electrode terminal and the negative electrode terminal, but the formation of the through-hole is not limited thereto, as the through-hole may be formed at various positions.

Then, the electrode assembly may be inserted through the opening formed on the side of the can S1120.

Thereafter, a cover may be coupled to the opening of the can S1130. In some embodiments, the can and the cover may be formed of a conductive metal such as stainless steel (SUS), aluminum, an aluminum alloy, or nickel-plated steel to form an overall appearance of the secondary battery. In some embodiments, the can and the cover may be joined to form the appearance of the secondary battery. The can and the cover may be metal-joined. Particularly, flange of the can and an edge of the cover may be joined. In addition, after the can and the cover are joined by metal, at least a part of the flange may be cut using a laser to improve an energy density of the secondary battery.

Thereafter, an electrolyte may be injected into the can through the through-hole S1140.

Finally, a sealer may be inserted into the through-hole to seal the through-hole S1150. The sealer may include a flat portion disposed on an outer side of the can to seal a periphery of the through-hole, may include a post portion connected to the flat portion and inserted into the through-hole, and may include a plate portion connected to the post portion and disposed on an inner side of the can to seal the periphery of the through-hole.

In some embodiments, the step of inserting the sealer into the through-hole to seal the through-hole S1150 may include pressing the flat portion using a presser so that the plate portion passes through the through-hole in a folded state. In some embodiments, the sealer may include an elastic material. The elastic material may be a substance that has a characteristic of returning to its original geometry when a force is removed after being deformed by an externally applied force. As a result, a height of the post portion may be less than a height of the through-hole before being inserted into the through-hole. The height of the post portion may correspond to the height of the through-hole when inserted into the through-hole. The meaning of “corresponds to” may be that the height of the post portion is the same as the height of the through-hole or is substantially the same within a predetermined error range. In relation to the elasticity described above, the sealer may include at least one of rubber, silicone, thermoplastic polyurethane (TPU), and thermoplastic elastomer (TPE). The plate portion of the sealer may be unfolded after passing through the through-hole in a folded state. When the secondary battery operates normally, the plate portion of the sealer may be disposed on an inner side of the can to seal the through-hole. Meanwhile, under a specific state or specific environmental conditions that are not normal, the secondary battery may operate abnormally, and an internal pressure of the secondary battery may be increased. At least a part of the plate portion may be folded by the internal pressure of the secondary battery. Accordingly, the sealer may detach from the through-hole when a pressure greater than or equal to a threshold value is generated inside the secondary battery. As a result, an internal gas of the secondary battery is discharged to an outside of the secondary battery, and, thus, safety of the secondary battery may be improved. By disposing a sealer that prevents electrolyte leakage and that may detach from the through-hole when a pressure greater than or equal to a threshold value forms inside the secondary battery, a manufacturing process of the secondary battery is simplified, and, thus, a manufacturing time and a manufacturing cost may be reduced.

The flowchart of FIG. 11 and the above descriptions of FIG. 11 are exemplary of some embodiments of the present disclosure, and the present disclosure is not limited to the flowchart of FIG. 11 and/or to the above descriptions of FIG. 11. One or more steps among the flowchart and the above descriptions of FIG. 11 may be added, changed, and/or deleted. Further, an order of one or more steps of FIG. 11 may be changed, and one or more steps may be performed simultaneously.

Although the present disclosure has been described above with respect to some embodiments, the present disclosure is not limited to the above-described embodiments. Various modifications and variations can be made to the above-described embodiments by those skilled in the art.

### EXPLANATION OF REFERENCE SYMBOLS

100: secondary battery
120: case
130: can
136: through-hole
140: cover
200: sealer
210: flat portion
220: post portion
230: plate portion

What is claimed is:

1. A secondary battery comprising:
an electrode assembly;
a can accommodating the electrode assembly through an opening formed on a side of the can, the can comprising a through-hole on another side of the can for injecting an electrolyte;
a cover that seals the opening; and
a sealer for sealing the through-hole, the sealer comprising:
a flat portion disposed on an outer side of the can to seal the through-hole and a periphery of the through-hole;
a post portion connected to the flat portion and inserted into the through-hole; and
a plate portion connected to the post portion and disposed on an inner side of the can to seal the through-hole and the periphery of the through-hole.

2. The secondary battery as claimed in claim 1, wherein the can comprises stainless steel, and
wherein the cover comprises stainless steel.

3. The secondary battery as claimed in claim 1, wherein the sealer comprises an elastic material,
wherein the post portion is configured to stretch in a direction of a central axis of the through-hole when inserted into the through-hole,
wherein the flat portion presses against an outer surface of the can surrounding the through-hole, and
wherein the plate portion presses against an inner surface of the can surrounding the through-hole.

4. The secondary battery as claimed in claim 1, wherein the sealer comprises an elastic polymer material.

5. The secondary battery as claimed in claim 1, wherein a melting point of the sealer is greater than or equal to 130° C.

6. The secondary battery as claimed in claim 1, wherein the sealer is configured to detach from the through-hole when a pressure greater than or equal to a threshold value forms inside the secondary battery.

7. The secondary battery as claimed in claim 1, wherein a geometry of the through-hole is a cylinder geometry or a polygonal tube geometry, and
wherein a geometry of the post portion is a circular cylinder geometry or a polygonal prism geometry.

8. The secondary battery as claimed in claim 1, wherein a geometry of the sealer, when inserted into the through-hole, is configured to be symmetrical with respect to a central axis of the through-hole.

9. The secondary battery as claimed in claim 1, wherein a geometry of the flat portion is a circular plate geometry, an elliptical plate geometry, or a polygonal plate geometry.

10. The secondary battery as claimed in claim 1, wherein a thickness of the flat portion is greater than or equal to a thickness of the plate portion.

11. The secondary battery as claimed in claim 1, wherein a geometry of the plate portion is a circular plate geometry, an elliptical plate geometry, or a polygonal plate geometry.

12. The secondary battery as claimed in claim 11, wherein an outer peripheral surface of the plate portion has a chamfered geometry.

13. The secondary battery as claimed in claim 1, wherein the plate portion comprises a convex curved surface facing a direction opposite to a direction in which the post portion is located.

14. The secondary battery as claimed in claim 7, wherein a thickness of the plate portion gradually decreases outward in a radial direction of the post portion.

15. The secondary battery as claimed in claim 1, wherein the plate portion comprises a concave curved surface facing a direction opposite to a direction in which the post portion is located.

16. The secondary battery as claimed in claim 7, wherein a thickness of the plate portion is less than or equal to a radius of the through-hole.

17. The secondary battery as claimed in claim 7, wherein a diameter of the post portion, when the sealer is not inserted into the through-hole, is configured to be less than or equal to a diameter of the through-hole.

18. The secondary battery as claimed in claim 1, wherein the sealer comprises an elastic material, and
wherein a height of the post portion of the sealer, when the sealer is not inserted into the through-hole, is configured to be less than a height of the through-hole.

19. A method for manufacturing a secondary battery, the method comprising:
preparing an electrode assembly;
preparing a can comprising an opening formed on a side of the can and a through-hole formed on another side of the can;
inserting the electrode assembly through the opening;
coupling a cover to the opening;
injecting an electrolyte into the can through the through-hole; and
inserting a sealer into the through-hole to seal the through-hole, the sealer comprising:
a flat portion disposed on an outer side of the can to seal a periphery of the through-hole;
a post portion connected to the flat portion and inserted into the through-hole; and
a plate portion connected to the post portion, the plate portion being disposed on an inner side of the can and sealing the periphery of the through-hole.

20. The method for manufacturing a secondary battery as claimed in claim 19, wherein inserting the sealer into the through-hole to seal the through-hole comprises pressing the flat portion using a presser so that the plate portion passes through the through-hole while in a folded state.
